(19) United States
(12) Patent Application Publication
(10) Pub. No.: US 2022/0255906 A1
(43) Pub. Date: Aug. 11, 2022

(54) System For Protecting Control Data Packet And Method Pertaining To Same

(71) Applicant: PRIBIT Technology, Inc., Geumcheon-gu, Seoul (KR)

(72) Inventors: Young Rang Kim, Seoul (KR); Hyun Seok Woo, Seoul (KR)

(21) Appl. No.: 17/656,121

(22) PCT Filed: Sep. 24, 2020
(86) PCT No.: PCT/KR2020/012925

§ 371 Date: Mar. 23, 2022

Related U.S. Application Data
(63) Continuation-in-part of application No. 16/580,866, filed on Sep. 24, 2019, now Pat. No. 11,190,494.
Application No. 16/580,866 is a continuation-in-part of application No. 16/580,974, filed on Sep. 24, 2019.

(30) Foreign Application Priority Data
Sep. 14, 2020 (KR) 10-2020-0117543

(51) Int. Cl. H04L 9/40; H04L 69/22

(52) U.S. Cl. CPC H04L 63/0428; H04L 63/0236; H04L 63/0838; H04L 69/22

(57) ABSTRACT

A node includes: a communication circuit; a processor operatively connected to the communication circuit; and a memory which is operatively connected to the processor and stores an access control application. The memory may store instructions that, upon being executed by the processor, cause the node to: sense a controller access event with respect to an external server through the access control application; insert a first protection header to a first control data packet for requesting controller access, the first protection header including a protection information ID for identifying protection information used for authenticating the first control data packet, and first authentication information that is generated on the basis of the protection information and used for authenticating and checking the integrity of the first control data packet; and transmit the first control data packet having the inserted first protection header to the external server by using the communication circuit.

### CROSS-REFERENCE TO RELATED APPLICATIONS

The present application is the National Stage of International Application No. PCT/KR2020/012925, filed on Sep. 24, 2020, which claims priority from U.S. patent application Ser. No. 16/580,866, filed on Sep. 24, 2019, and Ser. No. 16/580,974, filed on Sep. 24, 2019. International Application No. PCT/KR2020/012925 claims priority from Korean Patent Application No. 10-2020-0117543, filed on Sep. 14, 2020. The present application is a continuation-in-part of U.S. patent application Ser. No. 16/580,974, filed on Sep. 24, 2019. All prior applications are herein incorporated by reference.

### TECHNICAL FIELD

Embodiments disclosed in the present disclosure relates to technologies for protecting a control data packet in a network environment.

### BACKGROUND ART

A plurality of devices may communicate data over a network. For example, a smartphone may transmit or receive data with a server over the Internet. The network may include a private network such as an intranet as well as a public network such as the Internet.

### DISCLOSURE

### Technical Problem

To ensure a secure network, a connectivity control network environment using a transmission control protocol/internet protocol (TCP/IP) may use a tunneling technology allowing network access of an authorized target through an authorized tunnel. In this case, the network environment may distinguish an authorized terminal from an unauthorized terminal using IP-based identification information.

Furthermore, the network environment may perform connectivity control in the form of central control by a controller. The controller may manage and control nodes such as a terminal and a gateway in an integrated manner and may allow access of an authorized node or may block access of an unauthorized node.

A controller-based network environment may be divided into a data plane in which a general data packet is transmitted and a control plane in which a control data packet is transmitted. On the data plane, data communication and forwarding between the node and a destination network may be performed. On the control plane, operations required for secure data communication, for example, authentication of the node, control session update, threat detection and report, a request and control for network access, or policy transmission, may be performed. The control plane and the data plane may be managed independently of each other.

The controller-based network environment may be vulnerable to a threat (e.g., man in the middle attack, session hijacking) which manipulates flow of a control data packet between the controller and the node. Particularly, because the control data packet transmitted to the controller does not have a structure where it is transmitted to an authorized tunnel, it may be vulnerable to a threat such as denial of service attack (Dos).

Furthermore, a plurality of tunnels may be needed when using the tunneling technology, but a specific node may have a limitation in generating the plurality of tunnels. For example, a node with degraded network performance, a mobile terminal with high physical, environmental restrictions, or an internet of thing (IoT) device may have restrictions on generating the plurality of tunnels.

Various Embodiment disclosed in the present disclosure is to provide a system for addressing the above-mentioned problem in a network environment and a method thereof.

### Technical Solution

According to an aspect of the present disclosure, a node may include a communication circuitry, a processor operatively connected with the communication circuitry, and a memory, operatively connected with the processor, storing an access control application. The memory may store instructions, when executed by the processor, causing the node to detect a controller access event for an external server by means of the access control application, insert a first protection header into a first control data packet for requesting controller access, wherein the first protection header includes a protection information identifier (ID) for identifying protection information used to authenticate the first control data packet and first authentication information which is generated based on the protection information and is used for authentication and integrity check of the first control data packet, and transmit the first control data packet into which the first protection header is inserted to the external server, using the communication circuitry.

According to another aspect of the present disclosure, a gateway may include receiving a data packet from a node, determining that the data packet is a control data packet based on a destination IP and a structure of the received data packet, inspecting a protection header of the control data packet, transmitting the control data packet to an external server, when the inspection succeeds, and dropping the control data packet, when the inspection does not succeed.

According to another aspect of the present disclosure, a server may include a communication circuitry, a memory storing a database, and a processor operatively connected with the communication circuitry and the memory. The processor may be configured to receive a first control data packet of a node requesting controller access, from a gateway, inspect a first protection header of the first control data packet, generate control flow between the node and the server, the inspection of the first protection header succeeds, and drop the first control data packet, when the inspection of the first protection header fails.

### Advantageous Effects

According to embodiments disclosed in the present disclosure, flow of a control data packet between a control node and a controller may be protected from a threat generated in a corresponding interval.

Furthermore, according to embodiments disclosed in the present disclosure, the flow of the control data packet may be protected by means of a structure of a similar form to a tunnel.

Furthermore, according to embodiments disclosed in the present disclosure, the control data packet may be securely delivered in a network environment where there is no tunnel between a terminal and the controller.

Furthermore, according to embodiments disclosed in the present disclosure, the controller may be protected from a threat such as Dos.

In addition, various effects ascertained directly or indirectly through the present disclosure may be provided.

### DESCRIPTION OF DRAWINGS

FIG. 1 illustrates a controller-based network environment;

FIG. 2 illustrates flow of a control data packet according to various embodiments;

FIG. 3 is a functional block diagram illustrating a database stored in a controller according to various embodiments;

FIG. 4 illustrates a functional block diagram of a terminal according to various embodiments;

FIG. 5 illustrates a signal sequence diagram for controller access according to various embodiments;

FIG. 6 illustrates a user interface screen for controller access according to various embodiments;

FIG. 7 illustrates an operational flowchart of a terminal for controller access according to various embodiments;

FIG. 8 illustrates an operational flowchart of a gateway for controller access according to various embodiments;

FIG. 9 illustrates an operational flowchart of a controller for controller access according to various embodiments;

FIG. 10 illustrates a signal sequence diagram for controller control according to various embodiments;

FIG. 11 illustrates an operational flowchart of a terminal for controller control according to various embodiments;

FIG. 12 illustrates an operational flowchart of a gateway for controller control according to various embodiments;

FIG. 13 illustrates an operational flowchart of a controller for controller control according to various embodiments;

FIG. 14 illustrates a signal sequence diagram for access end according to various embodiments; and

FIG. 15 illustrates a user interface screen indicating that access is ended according to various embodiments.

With regard to description of drawings, the same or similar denotations may be used for the same or similar components.

### MODE FOR INVENTION

Hereinafter, various embodiments of the disclosure will be described with reference to accompanying drawings. However, it should be understood that this is not intended to limit the present disclosure to specific implementation forms and includes various modifications, equivalents, and/or alternatives of embodiments of the present disclosure.

A singular form of a noun corresponding to an item in the present disclosure may include one or plural of the items, unless the relevant context clearly indicates otherwise. In the present disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Such terms as “1st” and “2nd,” or “first” and “second” may be used to simply distinguish a corresponding component from another, and does not limit the components in other aspect (e.g., importance or order). It is to be understood that if any (e.g., a first) component is referred to, with or without the term “operatively” or “communicatively”, as “coupled with,” “coupled to,” “connected with,” or “connected to” another (e.g., a second) component, it means that the element may be coupled with the other element directly (e.g., wiredly), wirelessly, or via a third component.

Each (e.g., a module or a program) of components described in the present disclosure may include singular or plural entities. According to various embodiments, one or more of corresponding components or operations may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

As used in the present disclosure, the term “module” may include a unit implemented in hardware, software, or firmware, and may interchangeably be used with other terms, for example, “logic,” “logic block,” “part,” or “circuitry”. A module may be an integral part, or a minimum unit or portion thereof, adapted to perform one or more functions. For example, according to an embodiment, the module may be implemented in the form of an application-specific integrated circuit (ASIC).

Various embodiments of the present disclosure may be implemented as software (e.g., a program or an application) including instructions that are stored in a machine-readable storage medium (e.g., a memory). For example, a processor of the machine may invoke at least one of the stored one or more instructions from the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not differentiate between where data is semipermanently stored in the storage medium and where data is temporarily stored in the storage medium.

A method according to various embodiments disclosed in the present disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least a part of the computer program product may be temporarily generated or at least temporarily stored in the machine-readable storage medium, such as a memory of the manufacturer's server, a server of the application store, or a relay server.

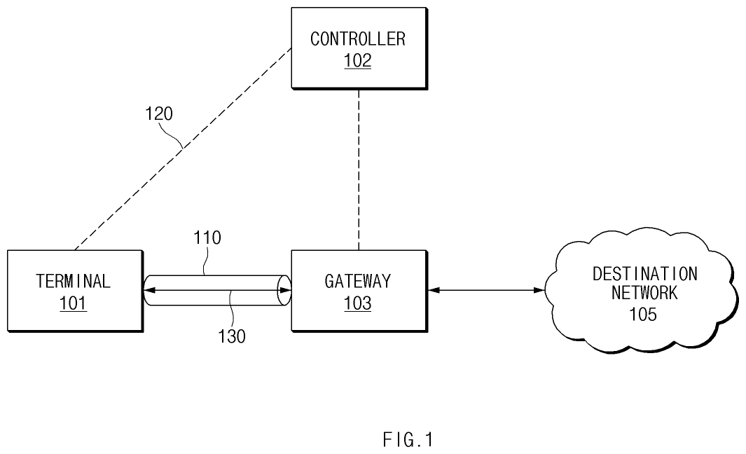

FIG. 1 illustrates a controller-based network environment.

Referring to FIG. 1, the number of the terminals 101, the gateways 103, and destination networks 105 is not limited to the number shown in FIG. 1. For example, the terminal 101 may transmit data to a plurality of destination networks through a plurality of gateways, and a controller 102 may manage a plurality of terminals and the plurality of gateways. Embodiments described below will mainly describe flow of a data packet between a controller and a terminal, but the same example is applicable to flow of a control data packet between the controller and a control node. The control node may include a terminal and a gateway.

The terminal 101 may be various types of devices capable of performing data communication. For example, the terminal 101 may include a portable device, such as a smartphone and a tablet, a computer device, such as a desktop or a laptop, a multimedia device, a medical device, a camera, a wearable device, a virtual reality (VR) device, or a home appliance, but not limited to the above-mentioned devices. The terminal 101 may be referred to as a ‘node’ or an ‘electronic device’.

The controller 102 may be, for example, a server (or a cloud server). The controller 102 may manage data transmission among the terminal 101, the gateway 103, and another network (e.g., the destination network 105) to ensure trusted data transmission in a network environment. For example, the controller 102 may manage access of the terminal 101 to the destination network 105 by means of policy information or blacklist information, may mediate generation of a tunnel 110 between the terminal 101 and the gateway 103, or may remove the tunnel 110 depending on a security event collected from the terminal 101 or the gateway 103. The terminal 101 may communicate with the destination network 105 through only the tunnel authorized by the controller 102. When there is no authorized tunnel 110, access of the terminal 101 to the destination network 105 may be blocked. According to an embodiment, the controller 102 may transmit and receive a control data packet with the terminal 101 to perform various operations (e.g., registration, grant, authentication, update, and end) associated with network access of the terminal 101. Flow (e.g., 250) in which the control data packet is transmitted may be referred to as control flow.

The gateway 103 may be located on a boundary of a network to which the terminal 101 belongs or a boundary of the destination network 105. The gateway 103 may be plural in number. The gateway 103 may forward only a data packet received through the authorized tunnel 110 among data packets received from the terminal 101 to the destination network 105. Flow (e.g., 130) in which a data packet is transmitted between the terminal 101 and the gateway 103 or between the gateway 103 and the destination network 105 may be referred to as data flow. According to an embodiment, the gateway 103 may be connected with the controller 102 based on a cloud. The gateway 103 may generate the authorized tunnel 110 with the terminal 101 under control of the controller 102.

As shown in FIG. 1, when there is the tunnel 110 for the data flow 130 and when there is no tunnel for the control flow 120, the control flow 120 may be attacked from another threat. It is able to consider a scheme of generating an additional tunnel between the terminal 101 and the controller 102 to protect the control flow 120, but network performance may be degraded or it may be difficult for a terminal, such as an IoT device, having high physical constraints to generate a tunnel.

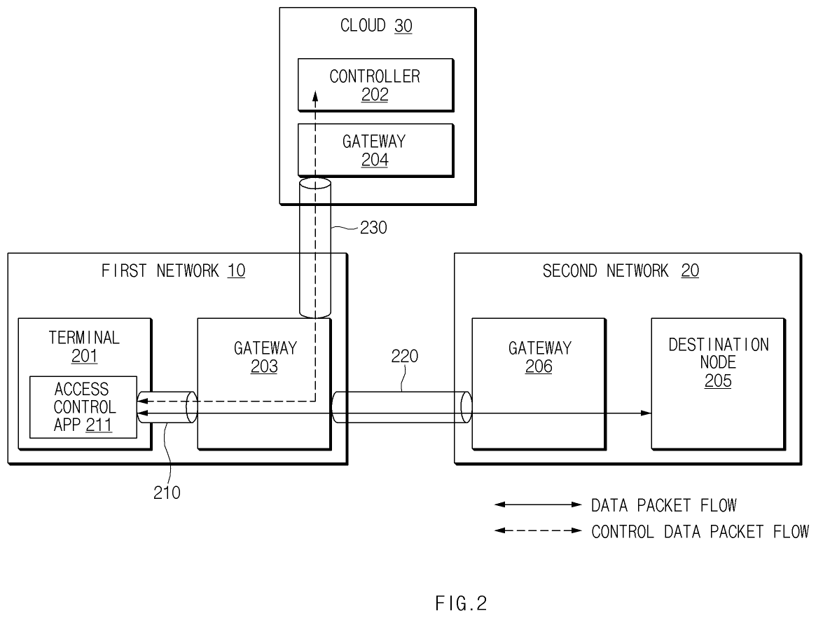

FIG. 2 illustrates flow of a control data packet according to various embodiments.

Referring to FIG. 2, a first network 10 and a second network 20 may be different networks. For example, the first network 10 may be a private network such as an intranet, and the second network 20 may be a public network such as the Internet. A terminal 201 may perform the same or similar function to a terminal 101 of FIG. 1. A controller 202 may perform the same or similar function to a controller 102 of FIG. 1. A gateway 203, 204, or 206 may perform the same or similar function to a gateway 103 of FIG. 1. The second network 20 may have the same or similar structure to a destination network 105 of FIG. 1.

The terminal 201 included in the first network 10 may perform data communication on a data plane with a destination node 205 included in the second network 20. For example, the terminal 201 may transmit a data packet (a general data packet) to the destination node 205 through the gateway 203 located at a boundary of the first network 10 and the gateway 206 located at a boundary of the second network 20. In this case, the data packet transmitted from the terminal 201 may be delivered to the destination node 205 through a tunnel 210 located between the terminal 201 and the gateway 203 and a tunnel 220 located between the gateways 203 and 206. The tunnel 210 or 220 may be a tunnel authorized by the controller 202.

The terminal 201 may transmit and receive a control data packet on a control plane with the controller 202 located in the cloud 30. For example, the terminal 201 may perform a control access procedure or a controller control procedure with the controller 202 through the gateway 204 located at a boundary between the gateway 203 and the cloud 30. A control data packet which is transmitted from the terminal 201 and is transmitted to the terminal 201 may be delivered through the tunnel 210 located between the terminal 201 and the gateway 203 and a tunnel 230 located between the gateways 203 and 204.

According to an embodiment, the gateway 203 may control transmission of a control data packet through the tunnels 210 and 230 authorized by the controller 202. For example, the gateway 203 may inspect a control data packet received from the terminal 201 or the other gateway 204, and may transmit an authenticated control data packet to a destination or may drop an unauthenticated control data packet, depending on the inspected result. The gateway 203 may control transmission of the control data packet to protect the terminal 201 and the controller 202 from the unauthenticated control data packet.

Although not illustrated in FIG. 2, according to an embodiment, the gateway 203 may include the same or similar type of application to an access control application 211 of the terminal 201 to control transmission of the control data packet.

According to an embodiment, the terminal 201 may include the access control application 211 for managing network access of an application stored in the terminal 201. The access control application 211 may generate control flow between the terminal 201 and the controller 202 under control of the controller 201 and may transmit or receive a control data packet through the generated control flow. For example, the access control application 211 may perform user authentication, a network access procedure requesting to access a destination network, or another controller control procedure.

According to an embodiment, the controller 202 may selectively process a control data packet transmitted from the terminal 201. For example, the controller 202 may authenticate the received control data packet and may drop an unauthenticated or unauthorized control data packet. Because a manager of a network environment is able to set a policy for controlling access between a source and a destination in the controller 202, more detailed network access control is possible.

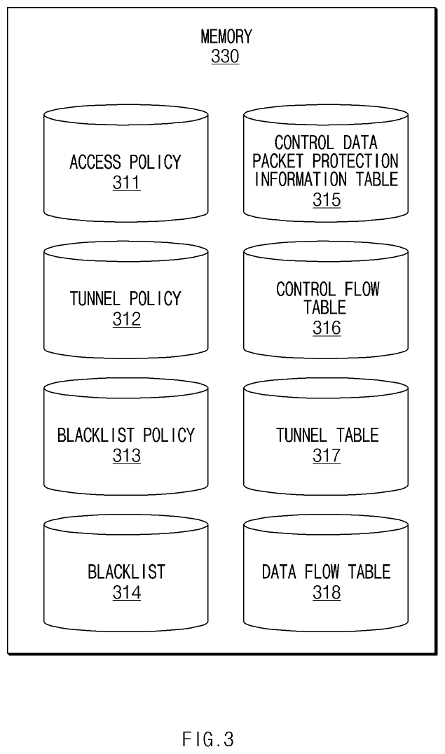

FIG. 3 is a functional block diagram illustrating a database stored in a controller (e.g., a controller 202 of FIG. 2) according to various embodiments.

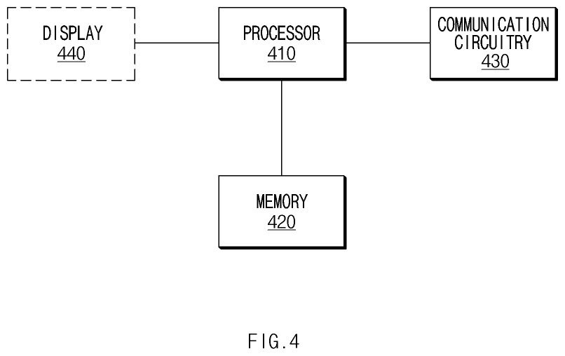

FIG. 3 illustrates only a memory 330, but the controller may further include communication circuitry (e.g., communication circuitry 430 of FIG. 4) for performing communication with an external electronic device (e.g., a terminal 201 or a gateway 203 of FIG. 2) and a processor (e.g., a processor 410 of FIG. 4) for controlling the overall operation of the controller.

Referring to FIG. 3, the controller may store databases 311 to 318 for controlling network access and data transmission in the memory 330.

The access policy database 311 may include information about an identified network, a network accessible by a terminal, a user or an application, and/or a service. For example, when access to a destination network (e.g., a second network 20 or a destination node 205 of FIG. 2) is requested from a terminal, the controller may determine whether the identified network (e.g., the network to which the terminal belongs), the terminal, a user (e.g., a user of the terminal), and/or an application (e.g., an application included in the terminal) are/is accessible to the destination network based on the access policy database 311.

The tunnel policy database 312 may include a type of a tunnel to be connected to a gateway which is present at a boundary between a source node (e.g., the terminal) and a network on a connection path, an encryption method, and encryption level information. For example, when access to the destination network is requested from the terminal, the controller provides the terminal with an optimal tunnel for accessing the destination network and information thereof based on the tunnel policy database 312.

The blacklist policy database 313 may include a policy for permanently or temporarily blocking access of a specific terminal. The blacklist policy database 313 may be generated based on a risk level of a security event among security events collected on a periodic basis from the terminal or the gateway, a cycle of occurrence, and/or information identified by means of an action analysis (e.g., at least one of a terminal identifier (ID), an IP address, a media access control (MAC) address, a user ID).

The blacklist database 314 may include a list of at least one of a terminal, an IP address, a MAC address, or a user blocked by the blacklist policy database 313. For example, when the terminal requesting to access the destination network is included in the blacklist database 314, the controller may deny the access request of the terminal to separate the terminal from the destination network.

The control data packet protection information table 315 may include an algorithm and code information for inserting a protection header when a control data packet is transmitted from the terminal, an algorithm and code information for checking validity of the inserted protection header, checking integrity, and verifying a denial prevention element, and/or an encryption and decryption algorithm and key information for ensuring confidentiality of the control data packet.

According to an embodiment, the control data packet protection information table 315 may be stored in a gateway. The gateway may inspect a protection header of the control data packet based on the control data packet protection information table 315.

The control flow table 316 is an example of a session table for managing flow (e.g., control flow) of a control data packet generated between the terminal and the controller. When the terminal successfully accesses the controller, control flow and identification information about the control flow may be generated by the controller. The control flow information may include at least one of identification information of control flow, an IP address identified when accessing and authenticating the controller, a terminal ID, or a user ID. For example, when access to the destination network is requested from the terminal, the controller may search for control flow information by means of the control flow identification information received from the terminal and may map at least one of the IP address, the terminal ID, or the user ID included in the found control flow information to the access policy database 311, thus determining whether access of the terminal is possible and whether to generate a tunnel.

According to an embodiment, the control flow may have an expiration time. The terminal should update the expiration time of control flow. When the expiration time is not updated during a certain time, the control flow (or control flow information) may be removed. Furthermore, when it is determined to need to immediately block access depending on a security event collected from the terminal or the gateway, the controller may remove the control flow depending on an access end request of the terminal. When the control flow is removed, because the tunnel and the data flow, which are previously generated, are also removed, access of the terminal to a network may be blocked.

According to an embodiment, to protect a control data packet transmitted and received between the terminal and the controller after the control flow is generated, the control flow table 316 may include a control data packet protection information ID (or a ‘protection information ID’).

The tunnel table 317 may be a table for managing a tunnel connected between the terminal and a gateway, a tunnel connected between the gateway and the gateway, or a tunnel connected between the gateway and a destination node. The tunnel may be generated for, for example, each device or IP. When a tunnel is generated between the terminal and the gateway, between the gateway and the gateway, or between the gateway and the destination node, the tunnel table 317 may include identification information of the tunnel, control flow identification information when the tunnel is dependent on control flow, a tunnel end point (TEP), a tunnel start point (TSP), a tunnel algorithm, a tunnel type, and/or additional information for managing the tunnel.

The data flow table 318 may be a table for managing flow (e.g., data flow) in which a detailed data packet is transmitted between the terminal and the gateway. The data flow may be generated for each TCP session in the tunnel, for each application of a source terminal, or in a more detailed unit. The data flow table 318 may include data flow identification information, control flow identification information when data flow is dependent on control flow, an application ID for identifying data flow of an authorized target, a destination IP address, and/or a service port.

FIG. 4 illustrates a functional block diagram of a terminal (e.g., a terminal 201 of FIG. 2) according to various embodiments.

Referring to FIG. 4, the terminal may include a processor 410, a memory 420, and communication circuitry 430. According to an embodiment, the terminal may further include a display 440 for performing an interface with a user.

The processor 410 may control the overall operation of the terminal. In various embodiments, the processor 410 may include one processor single core or may include a plurality of processor cores. For example, the processor 410 may include a multi-core such as a dual-core, a quad-core, or a hexa-core. According to embodiments, the processor 410 may further include a cache memory located internally or externally. According to embodiments, the processor 410 may be configured with one or more processors. For example, the processor 410 may include at least one of an application processor, a communication processor, or a graphical processing unit (GPU).

All or a portion of the processor 410 may be electrically or operatively coupled with or connected to another component (e.g., the memory 420, the communication circuitry 430, or the display 440) in the terminal. The processor 410 may receive commands of other components of the terminal, may interpret the received commands, and may perform calculation or may process data, depending on the interpreted commands. The processor 410 may interpret and process a message, data, an instruction, or a signal received from the memory 420, the communication circuitry 430, or the display 440. The processor 410 may generate a new message, data, instruction, or signal based on the received message, data, instruction, or signal. The processor 410 may provide the memory 420, the communication circuitry 430, or the display 440 with the processed or generated message, data, instruction, or signal.

The processor 410 may process data or a signal which is generated or occurs by a program. For example, the processor 410 may request an instruction, data, or a signal from the memory 420 to run or control the program. The processor 410 may record (or store) or update an instruction, data, or a signal in the memory 420 to run or control the program.

The memory 420 may store an instruction controlling the terminal, a control instruction code, control data, or user data. For example, the memory 420 may include at least one of an application program, an operating system (OS), middleware, or a device driver.

The memory 420 may include one or more of a volatile memory or a non-volatile memory. The volatile memory may include a dynamic random access memory (DRAM), a static RAM (SRAM), a synchronous DRAM (SDRAM), a phase-change RAM (PRAM), a magnetic RAM (MRAM), a resistive RAM (RRAM), a ferroelectric RAM (FeRAM), or the like. The non-volatile memory may include a read only memory (ROM), a programmable ROM (PROM), an electrically programmable ROM (EPROM), an electrically erasable programmable ROM (EEPROM), a flash memory, or the like.

The memory 420 may further include a non-volatile medium such as a hard disk drive (HDD), a solid state disk (SSD), an embedded multi media card (eMMC), or a universal flash storage (UFS).

The communication circuitry 430 may assist in establishing a wired or wireless communication connection between the terminal and an external electronic device (e.g., a controller 202 or a gateway 203 of FIG. 2) and performing communication through the established connection. According to an embodiment, the communication circuitry 430 may include wireless communication circuitry (e.g., cellular communication circuitry, short range wireless communication circuitry, or global navigation satellite system (GNSS) communication circuitry) or wired communication circuitry (e.g., local area network (LAN) communication circuitry or power line communication circuitry) and may communicate with the external electronic device over a short range communication network, such as Bluetooth, WiFi direct, or infrared data association (IrDA), or a long range communication network, such as a cellular network, the Internet, or a computer network using the corresponding communication circuitry among them. The above-mentioned several types of communication circuitry 430 may be implemented as one chip or may be respectively implemented as separate chips.

The display 440 may output content, data, or a signal. In various embodiments, the display 440 may display image data processed by the processor 410. According to embodiments, the display 440 may be combined with a plurality of touch sensors (not shown) capable of receiving a touch input or the like to be configured with an integrated touch screen. When the display 440 is configured with the touch screen, the plurality of touch sensors may be arranged over the display 440 or under the display 440.

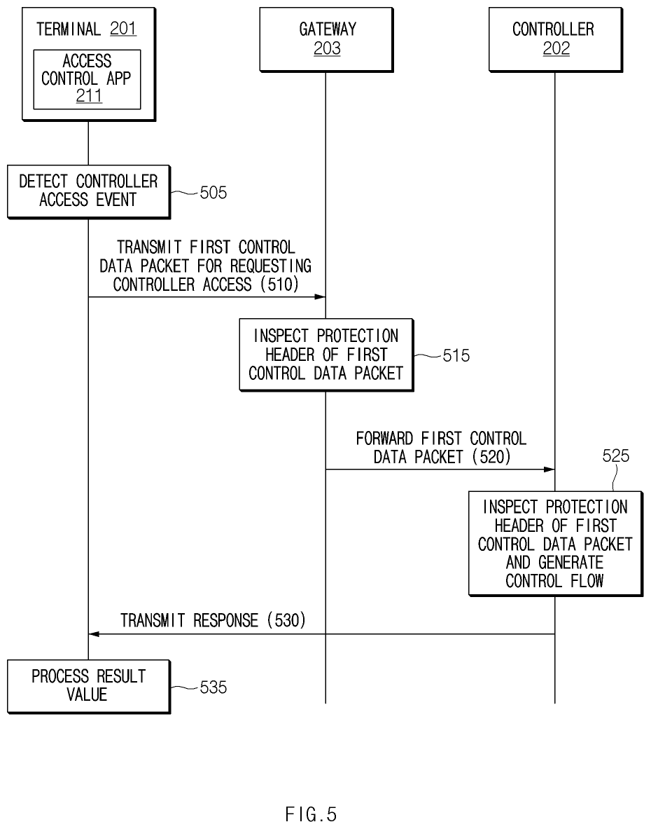

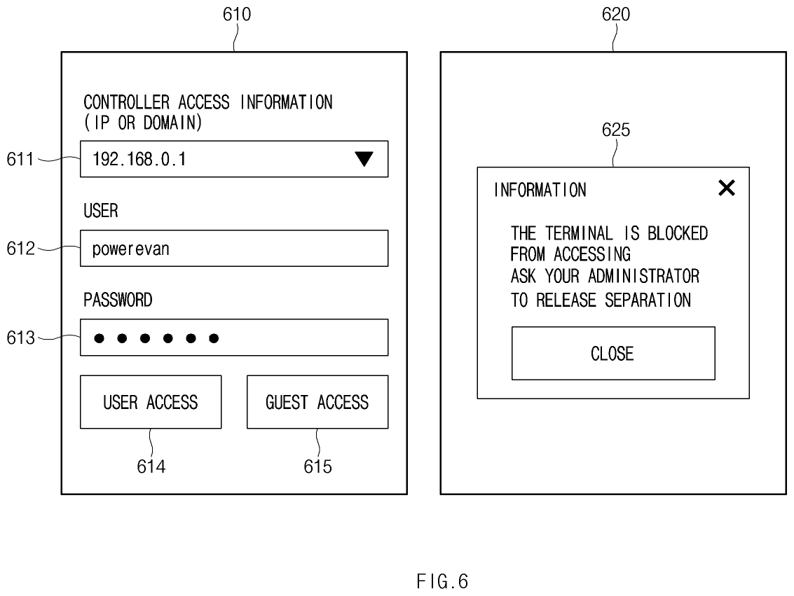

FIGS. 5 and 6 illustrate an operation for controller access according to various embodiments. FIG. 5 illustrates a signal sequence diagram for controller access. FIG. 6 illustrates a user interface screen for controller access.

Because a terminal 201 needs to be authorized by a controller 202 to access a destination network or a destination node, an access control application 211 of the terminal 201 may attempt controller access of the terminal 201 by requesting the controller 202 to generate control flow.

Referring to FIG. 5, in operation 505, the terminal 201 may detect a controller access event. For example, the access control application 211 is installed and run in the terminal 201, and the terminal 201 may detect that access to the controller 202 is requested by means of the access control application 211.

As an example, referring to FIG. 6, when the access control application 211 is run, the terminal 201 may display a user interface screen 610 for receiving necessary information for controller access. The user interface screen 610 may include an input window 611 for inputting an IP or a domain of the controller 202, an input window 612 for inputting a user ID, and/or an input window 613 for inputting a password. By receiving a button 614 where an authenticated user accesses the controller after pieces of information about the input windows 611 to 613 are input, the terminal 201 may detect a controller access event. As another example, when the user authentication of the terminal 201 is not completed yet, the terminal 201 may detect the controller access event by receiving a button 615 where an unauthorized user (i.e., a guest) accesses the controller.

In operation 510, the terminal 201 may transmit a first data packet for a request of controller access in response to detecting the controller access event. The terminal 201 may request the controller access by means of the access control application 211. The access control application 211 may transmit identification information (e.g., a terminal ID, an IP address, or a MAC address) of the terminal 201, a type of the terminal 201, a location of the terminal 201, an environment of the terminal 201, identification information of a network to which the terminal 201 belongs, and/or identification information of the access control application as a portion of the first data packet.

According to an embodiment, a first control data packet may be encrypted or authenticated using control data packet protection information (or referred to as ‘protection information’) included in the access control application 211. For example, the access control application 211 may insert a control data packet protection header (or referred to as a ‘protection header’) generated based on the control data packet protection information into the first control data packet. The protection header may include, for example, identification information (hereinafter, referred to as a ‘control data packet protection information ID’ or a ‘protection information ID’) for identifying control data packet protection information used to encrypt the first control data packet and/or authentication information for authenticating the first control data packet and checking integrity. The authentication information may include one-time password (OTP) identification information for identifying a type of an OTP algorithm, an OTP value generated by the OTP algorithm, and an OTP counter for identifying whether the OTP value is true or false by comparing the OTP value with a counter value. In addition, the first control data packet (or the protection header) may include control flow ID initialization information for identifying initialization encryption key information to be used to generate control flow (e.g., 120 of FIG. 1) between the terminal 201 and a controller 202.

In operation 515, a gateway 203 (or a gateway 204 of FIG. 2) may inspect a protection header of the first control data packet received from the terminal 201. For example, the gateway 203 may search a control data packet protection table stored in the gateway 203 based on identification information for identifying the first control data packet transmitted to the controller 202 among the received data packets and a protection information ID included in the identified first control data packet. The gateway 203 may perform authentication and integrity check for the first control data packet based on the found control data packet protection table and authentication information of the protection header included in the first control data packet.

When it fails to inspect the protection header, the gateway 203 may drop the first control data packet and may transmit identification information of the terminal 201, which transmits the first control data packet, to the controller 202. The controller 202 may process the received identification information of the terminal 201 as a blacklist to separate the terminal 201.

When it succeeds in inspecting the protection header, in operation 520, the gateway 203 may forward the first control data packet to the controller 202.

In operation 525, the controller 202 may inspect the protection header of the first control data packet. For example, the controller 202 may perform authentication and integrity check for the first control data packet based on the protection header included in the received first control data packet and the control data packet protection table stored in the controller 202. Furthermore, the controller 202 may decrypt the encrypted first control data packet. When it fails to perform the authentication or the integrity check or when the decryption fails, the controller 202 may drop the first control data packet.

When it succeeds in performing the authentication and the integrity check and when the decryption succeeds, the controller 202 may process a controller access request of the terminal 201, which is indicated by the first control data packet. For example, the controller 202 may generate a control flow ID for control data packet flow authorized between the terminal 201 and the controller 202. The controller 202 may generate new control data packet protection information for updating control data packet protection information included in the access control application 211 or using the authorized control flow. The control data packet protection information generated by the controller 202 may include an algorithm and encryption key information used to protect the control data packet in the terminal 201 (or the gateway 203). The controller 202 may randomly select an algorithm and encryption key information from the control data packet protection information table or may select information with low frequency of use, such that a stealer is unable to infer new protection information.

In operation 530, the controller 202 may transmit a response including information associated with the generated control flow and new protection information to the terminal 201. As the information associated with the control flow is transmitted to the terminal 201, authorized control flow may be generated between the terminal 201 and the controller 202.

In operation 535, the terminal 201 may process a result value depending on the received response. For example, when the received response indicates that the terminal 201 is accessible, the access control application 211 may store identification information of the received control flow and may update the control data packet protection information. The terminal 201 may encrypt a control data packet using the updated control data packet protection information, when subsequently transmitting a control data packet.

Furthermore, the access control application 211 may display a user interface screen indicating that the controller access is completed to a user. When the controller access is completed, a network access request of the terminal 201 for a destination network may be controlled by the controller 202.

According to another embodiment, when authentication and integrity check of the first control data packet fail or when the controller 202 determines that access of the terminal 201 is impossible, the controller 202 may not generate control flow in operation 525 and may transmit a response indicating that access of the terminal 201 is impossible in operation 530.

When receiving the response indicating that the access of the terminal 201 is impossible, in operation 535, the terminal 201 may output a user interface screen indicating that controller access is impossible to the user. For example, referring to FIG. 6, the terminal 201 may display a user interface screen 620 by means of the access control application 211. The user interface screen 620 may indicate that access of the terminal 201 is blocked and may include a user interface 725 guiding separation release through a manager (e.g., the controller 202).

Through the above-mentioned operation, as the control data packet is encrypted and inspection for authentication, integrity, and denial prevention of the control data packet is performed, flow of the control data packet may be protected from a similar structure to a tunnel.

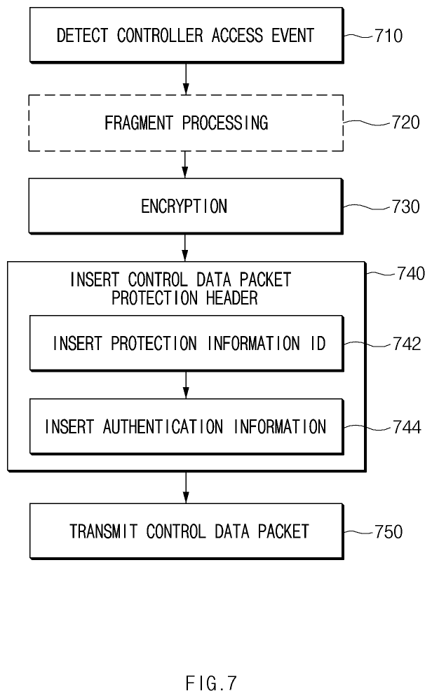

FIG. 7 illustrates an operational flowchart of a terminal for controller access according to various embodiments. Operations described below may be performed by a terminal 201 of FIG. 5. For example, the terminal may execute instructions stored in a memory (e.g., a memory 420 of FIG. 4) by means of a processor (e.g., a processor 410 of FIG. 4) to perform operations of FIG. 7. The instructions stored in the memory may be software or a program such as an access control application 211 of FIG. 5.

Referring to FIG. 7, in operation 710, the terminal may detect a controller access event for an external server (e.g., a controller 202 of FIG. 5). For example, when the access control application in the terminal is run, the run access control application may input an access IP or domain information of the external server to receive a user input attempting access.

In operation 720, the access control application may fragment the data packet. For example, the terminal may calculate a length of a data packet, into which the protection header is inserted, which increases when the payload is encrypted, and may fragment a control data packet with regard to the calculated value and a magnitude of a maximum transmission unit (MTU) of the terminal. If necessary, the terminal may fail to perform operation 720.

In operation 730, the terminal may encrypt a control data packet (e.g., a first control data packet of FIG. 5) (or the fragmented control data packet) for a controller access request using an encryption key included in the access control application.

In operation 740, the terminal may insert a protection header into each of the fragmented control data packets. According to an embodiment, the protection header may be used for authentication and integrity of a control data packet transmitted by the terminal. The protection header may include, for example, control flow ID initialization information, a protection information ID for identifying protection information used to encrypt the control data packet, and/or authentication information. The authentication information may include OTP information such as OTP identification information, an OTP value, and an OTP counter. The access control application may insert a protection header into the control data packet by means of operations included in operation 740, an order of each operation is merely illustrative, and the order may be changed. Furthermore, if necessary, the access control application may omit at least some of the operations included in operation 740. An order of operation 720 and operation 740 may be changed and may be performed at the same time.

In operation 742, the access control application may insert a protection information ID into the control data packet such that a gateway and the external server may identify control data packet protection information included in the access control application and an algorithm associated with the corresponding information. The protection information ID may be referred to as OTP identification information.

In operation 744, the access control application may insert OTP information included in the control data packet protection information into the control data packet. The OTP information and the algorithm may include at least one of an HMAC based one-time password (HOTP), a time based one-time password (TOTP), or a random number generation and verification algorithm mutually agreed between the terminal and the external server.

For example, the control data packet into which the protection information ID and the OTP information are inserted may be exemplified as Table 1 below.

TABLE 1

| | Control Data Packet Protection Header | | | | |
|---|---|---|---|---|---|
| | Control | | | | |
| | Flow ID | Protection | | | |
| | Initialization | Information | OTP | OTP | |
| IP Header | Information | ID | Value | Counter | Payload |
| . . . | 0x99000000 | 0x98000000 | 0x97000000 | 0x96000000 | Encrypted Data |
| . . . | 0x99000000 | 0x98000000 | 0x97000000 | 0x96000000 | Encrypted Data |

In detail, the control flow ID initialization information (e.g., 4 bytes) may include an identification header (e.g., 0x99) for detecting whether there is a control data packet and a control data packet initialization encryption ID value (e.g., 3 bytes). The protection information ID (e.g., 4 bytes) may include an identification header (e.g., 0x98) capable of detecting whether there is an OTP algorithm and an ID value (e.g., 3 bytes) capable of identifying a type of the OTP algorithm. The OTP value (e.g., 4 bytes) may include an identification header (e.g., 0x97) capable of detecting whether there is an OTP value and a value (e.g., 3 bytes) generated by a type of the OTP algorithm. The OTP counter (e.g., 4 bytes) may include a value (e.g., 3 bytes) for comparing an identification header (e.g., 0x96) capable of identifying whether there is the OTP counter and an OTP value generated by a type of the OTP algorithm with the OTP counter to identify whether the OTP value is true or false.

In operation 750, the terminal may transmit the control data packet into which the protection header is inserted.

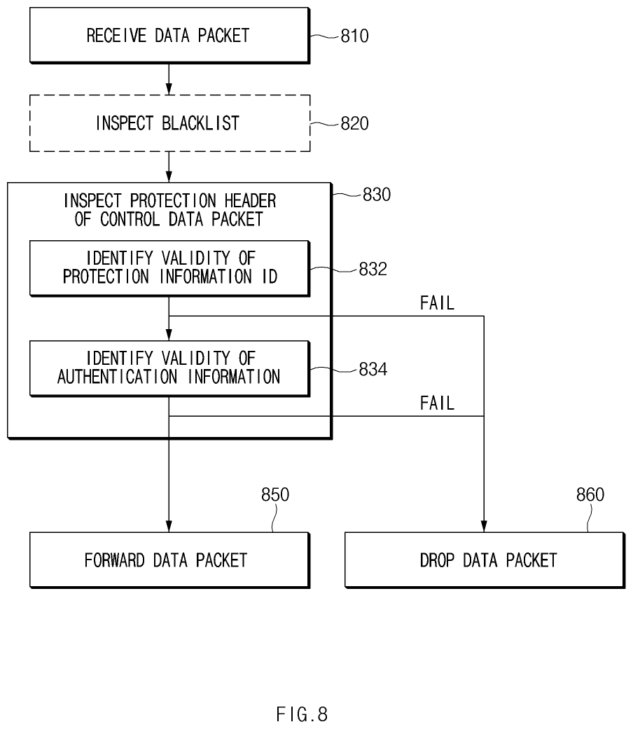

FIG. 8 illustrates an operational flowchart of a gateway for controller access according to various embodiments. Operations described below may be performed by gateway 203 of FIG. 5. For example, the gateway may execute a security program such as an access control application 211 of FIG. 5 to perform operations of FIG. 8.

Referring to FIG. 8, in operation 810, the gateway may receive a data packet from a terminal (e.g., a terminal 201 of FIG. 5). The gateway may determine whether the received data packet is a control data packet based on a destination IP included in the received data packet and a structure of the data packet.

When the received data packet is a control data packet (e.g., a first control data packet of FIG. 5), in operation 830, the gateway may inspect a protection header of the control data packet. The gateway may inspect the protection header of the control data packet based on operations included in operation 830, an order of each operation is merely illustrative, and the order may be changed. Furthermore, if necessary, the gateway may omit at least some of the operations included in operation 830. When any inspection of one of the operations included in operation 830 fails, the gateway may immediately perform operation 860 without performing subsequent operations.

In operation 832, the gateway may identify validity of a protection information ID included in the control data packet. For example, the gateway may identify the protection information ID included in the control data packet and may identify whether there is the identified protection information ID in a control data packet protection information table stored in the gateway. When the identified protection information ID is not included in the control data packet protection information table, the gateway may determine that the inspection fails and may drop the received data packet in operation 860.

When the identified protection information ID is included in the control data packet protection information table, in operation 834, the gateway may identify validity of authentication information included in the protection header. For example, the gateway may determine whether an OTP included in the protection header is valid based on OTP verification information and an algorithm in the control data packet protection information table. When there is no OTP in the received data packet or when OTP verification fails, the gateway may determine that the inspection fails and may drop the received data packet in operation 860.

When it succeeds in the inspection according to operation 832 and operation 834, the gateway may determine that it succeeds in inspecting the protection header of the control data packet and may forward a data packet to an external server (e.g., a controller 202 of FIG. 5) in operation 850.

According to an embodiment, to block access of an unauthorized external electronic device, in operation 820 before performing operation 830, the gateway may further perform blacklist inspection. For example, the gateway may identify whether a source IP included in an IP header of the received data packet is included in a blacklist of the gateway. When the source IP is included in the blacklist, the gateway may drop the received data packet without inspecting a protection header of the control data packet. When the source IP is not included in the blacklist, the gateway may perform operation 830.

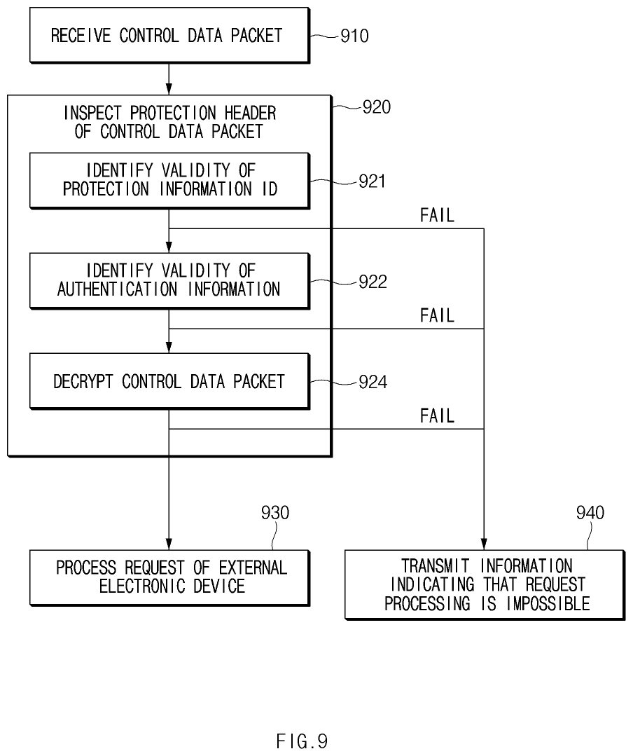

FIG. 9 illustrates an operational flowchart of a controller for controller access according to various embodiments. Operations described below may be performed by means of a controller 202 of FIG. 5. The controller may be referred to as a ‘server’.

Referring to FIG. 9, in operation 910, the controller may receive a control data packet (e.g., a first control data packet of FIG. 5) from a gateway (e.g., a gateway 203 of FIG. 5).

In operation 920, the controller may inspect a protection header of the received control data packet. The controller may inspect the protection header of the control data packet by means of operations included in operation 920, an order of each operation is merely illustrative, and the order may be changed. Furthermore, if necessary, the controller may omit at least some of the operations included in operation 920. When any inspection of one of the operations included in operation 920 fails, the controller may immediately perform operation 940 without performing subsequent operations.

In operation 921, the controller may identify validity of a protection information ID included in the control data packet. For example, the controller may identify the protection information ID included in the control data packet and may identify whether there is the identified protection information ID in a control data packet protection information table stored in the controller. When the identified protection information ID is not included in the control data packet protection information table, the controller may determine that the inspection fails and may transmit information indicating that it is impossible to process a request of a terminal (e.g., a terminal 201 of FIG. 5) in operation 940.

When the identified protection information ID is included in the control data packet protection information table, in operation 922, the controller may identify validity of authentication information included in the control data packet. For example, the controller may determine whether an OTP included in the protection header is valid based on OTP verification information and an algorithm in the control data packet protection information table. When there is no OTP in the received data packet or when OTP verification fails, the controller may determine that the inspection fails and may transmit information indicating that it is impossible to process the request of the terminal in operation 940.

When the verification succeeds, in operation 923, the controller may decrypt the received control data packet using a decryption key included in the control data packet information. When the decryption fails, the controller may not perform subsequent operations and may transmit information indicating that it is impossible to process the request of the terminal in operation 940.

When the operations included in operation 920 are completed, in operation 930, the controller may process the request of the terminal. For example, the controller may remove a protection header of the received control data packet. The controller may determine whether to allow a controller access request of the terminal based on whether information included in the control data packet (e.g., identification information of the terminal, a type of the terminal, a location of the terminal, an environment of the terminal, identification information of a network to which the terminal belongs, and/or identification information of an access control application) is matched to an access policy of the controller or whether identification information of the terminal or the network to which the terminal belongs is included in the blacklist.

When the access of the terminal is possible, the controller may generate control flow and may generate identification information (e.g., an ID) of the generated control flow in the form of a random number. The controller may store the identification information of the terminal and the network and the generated control flow ID in a control flow table. Thereafter, when the control data packet is transmitted from the terminal, the controller may identify whether the control data packet is received through authorized control flow based on the information stored in the control flow table.

According to an embodiment, the controller may generate new control data packet protection information to update a control data packet protection information table of the terminal. For example, the controller may randomly select an algorithm and encryption key information from the control data packet protection information table or may select information with low frequency of use, such that a stealer is unable to infer new control data packet protection information, to generate network control data packet protection information. The controller may add a protection information ID for the new control data packet protection information to control flow.

According to an embodiment, the controller may transmit the generated control flow ID and the new control data packet protection information to the terminal to respond to the request of the terminal. Because the new control data packet protection information is used when the terminal subsequently transmits a control data packet, a similar function to a tunnel on control data packet flow between the controller and the terminal may be applied.

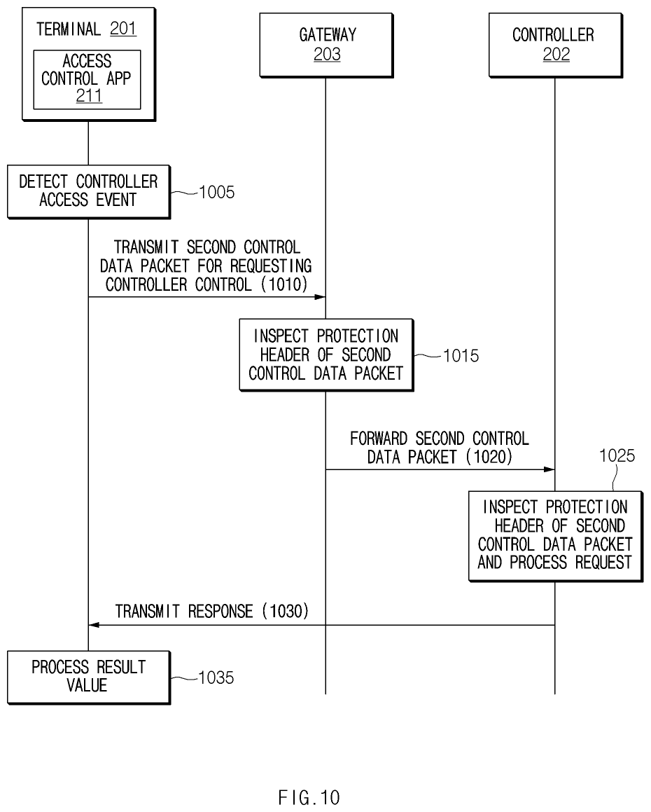

FIG. 10 illustrates a signal sequence diagram for controller control according to various embodiments.

When control flow is generated through control access, a terminal 201 may perform an additional procedure, such as user authentication, a network access procedure, access update, or policy reception, with a controller 202 through generated control flow. For another example, to notify the controller 202 that the terminal 201 is continuously enabled, report a security event generated in the terminal 201, or identify a policy and control information to be received from the controller, an access control application 211 may report a state of the terminal 201 to the controller 202 at a specified time interval or whenever a specified event (e.g., a change in network access information such as a WiFi router or network IP) occurs. Operations of FIGS. 10 to 13 described below describe an example of such an additional procedure, and other procedures may be applied in the same or similar manner.

Referring to FIG. 10, in operation 1005, the terminal 201 may detect a controller control event. For example, the access control application 211 may detect the controller control event based on user authentication, reception of a user input for network access, occurrence of a specified event, or lapse of a specified time.

In operation 1010, the terminal 201 may transmit a second data packet for requesting controller control in response to detecting the controller control event. The terminal 201 may request the controller control by means of the access control application 211.

According to an embodiment, the second control data packet may be encrypted based on a control data packet protection information table updated through a control access procedure. For example, the access control application 211 may insert a generated protection header into the second control data packet based on the updated control data packet protection information table. The protection header may include, for example, a protection information ID of the second control data packet, authentication information for authentication and integrity check of the second control data packet, and/or control flow identification information for identifying it is authorized control flow. The authentication information may include, for example, OTP identification information, an OTP value, and an OTP counter. In addition, the second control data packet (or the protection header) may include a control flow ID for authenticating that control flow (e.g., 120 of FIG. 1) generated between the terminal 201 and the controller 202 is authorized control flow.

In operation 1015, a gateway 203 (or a gateway 204 of FIG. 2) may inspect a protection header of the second control data packet received from the terminal 201. For example, the gateway 203 may search a control data packet protection table stored in the gateway 203 based on identification information for identifying the second control data packet transmitted to the controller 202 among the received data packets and a protection information ID included in the identified second control data packet. The gateway 203 may perform authentication and integrity check for the second control data packet based on the found control data packet protection table and the protection header included in the second control data packet.

When it fails to inspect the protection header, the gateway 203 may drop the second control data packet and may transmit identification information of the terminal 201, which transmits the second control data packet, to the controller 202. The controller 202 may process the received identification information of the terminal 201 as a blacklist to separate the terminal 201.

When it succeeds in inspecting the protection header, in operation 1020, the gateway 203 may forward the second control data packet to the controller 202.

In operation 1025, the controller 202 may inspect the protection header of the second control data packet. For example, the controller 202 may perform authentication and integrity check for the second control data packet based on the protection header included in the received second control data packet and a control flow table and the control data packet protection information table of the controller 202. Furthermore, the controller 202 may decrypt the encrypted second control data packet. When the authentication or the integrity check fails, when the control flow is not valid, or when the decryption fails, the controller 202 may drop the second control data packet. When it succeeds in inspecting the protection header, the controller 202 may process a controller access request of the terminal 201, which is indicated by the second control data packet.

In operation 1030, the controller 202 may transmit a response to the controller access request to the terminal 201.

In operation 1035, the terminal 201 may process a result value depending on the received response.

Through the above-mentioned operation, as the control data packet is encrypted and inspection for authentication, integrity, and denial prevention of the control data packet is performed and as an additional authentication procedure is performed after flow of the control data packet is authorized, the flow of the control data packet may be protected from a similar structure to a tunnel.

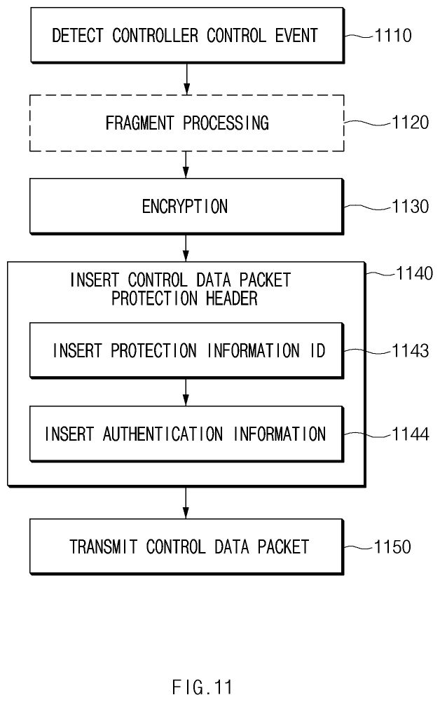

FIG. 11 illustrates an operational flowchart of a terminal for controller access according to various embodiments. Operations described below may be performed by a terminal 201 of FIG. 10. For example, the terminal may execute instructions stored in a memory (e.g., a memory 420 of FIG. 4) by means of a processor (e.g., a processor 410 of FIG. 4) to perform operations of FIG. 11. The instructions stored in the memory may be software or a program such as an access control application 211 of FIG. 10.

Referring to FIG. 11, in operation 1110, the terminal may detect a controller control event for an external server (e.g., a controller 202 of FIG. 5). For example, when a specified time elapses, when a security event is detected, or when a user input for user authentication or network access is received, an access control application installed in the terminal may detect that the controller control event occurs.

In operation 1120, the access control application may fragment a data packet. For example, the terminal may calculate a length of a data packet, into which the protection header is inserted, which increases when the payload is encrypted, and may fragment a control data packet with regard to the calculated value and a magnitude of an MTU of the terminal. If necessary, the terminal may fail to perform fragment processing.

In operation 1130, the terminal may encrypt a control data packet (e.g., a second control data packet of FIG. 10) (or the fragmented control data packet) for a controller control request using an encryption key of data packet protection information transmitted when generating control flow.

In operation 1140, the terminal may insert a protection header into each of the fragmented control data packets. According to an embodiment, the protection header may be used for authentication of transmission flow (e.g., control flow) of the control data packet, as well as authentication and integrity of the control data packet transmitted by the terminal. For example, the protection header may include a protection information ID, authentication information such as OTP information, and a control flow ID. The terminal may insert a protection header into the control data packet by means of operations included in operation 1140, an order of each operation is merely illustrative, and the order may be changed. Furthermore, if necessary, the access control application may omit at least some of the operations included in operation 1140. In an embodiment, an order of operation 1130 and operation 1140 may be changed and may be performed at the same time.

In operation 1143, the access control application may insert a protection information ID, included in the control data packet protection information transmitted when generating control flow, into the control data packet to be identified by a gateway and a controller. The protection information ID may be referred to as OTP identification information.

In operation 1144, the access control application may insert OTP information included in the control data packet protection information into the control data packet. The OTP information and the algorithm may include at least one of an HMAC based one-time password (HOTP), a time based one-time password (TOTP), or a random number generation and verification algorithm mutually agreed between the terminal and the external server.

For example, the control data packet into which the protection information ID and the OTP information are inserted may be exemplified as Table 2 below.

TABLE 2

| | Control Data Packet Protection Header | | | | |
|---|---|---|---|---|---|
| | | Protection | | | |
| | Control | Information | OTP | OTP | |
| IP Header | Flow ID | ID | Value | Counter | Payload |
| . . . | 0x99000000 | 0x98000000 | 0x97000000 | 0x96000000 | Encrypted Data |
| . . . | 0x99000000 | 0x98000000 | 0x97000000 | 0x96000000 | Encrypted Data |

In detail, the control flow ID (e.g., 4 bytes) may include an identification header (e.g., 0x99) for detecting whether there is a control data packet and a control flow unique ID value (e.g., 3 bytes) converted when it is requested to generate control flow. The protection information ID (e.g., 4 bytes) may include an identification header (e.g., 0x98) capable of detecting whether there is an OTP algorithm and an ID value (e.g., 3 bytes) capable of identifying a type of the OTP algorithm. The OTP value (e.g., 4 bytes) may include an identification header (e.g., 0x97) capable of detecting whether there is an OTP value and a value (e.g., 3 bytes) generated by a type of the OTP algorithm. The OTP counter (e.g., 4 bytes) may include a value (e.g., 3 bytes) for comparing an identification header (e.g., 0x96) capable of identifying whether there is the OTP counter and an OTP value generated by a type of the OTP algorithm with OTP counter to identify whether the OTP value is true or false.

In operation 1150, the terminal may transmit the control data packet into which the protection header is inserted.

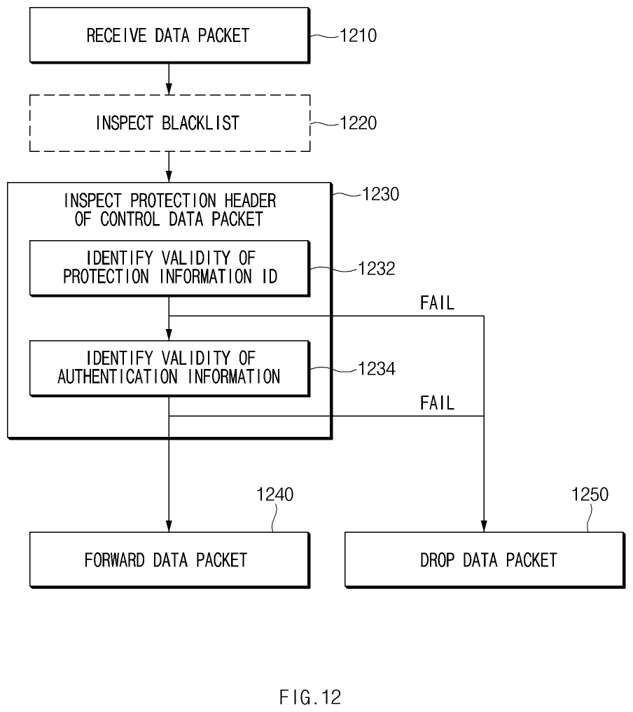

FIG. 12 illustrates an operational flowchart of a gateway for controller control according to various embodiments. Operations described below may be performed by gateway 203 of FIG. 10. For example, the gateway may execute a security program such as an access control application 211 of FIG. 10 to perform operations of FIG. 12.

Referring to FIG. 12, in operation 1210, the gateway may receive a data packet from a terminal (e.g., a terminal 201 of FIG. 10). The gateway may determine whether the received data packet is a control data packet based on a destination IP included in the received data packet and a structure of the data packet.

When the received data packet is a control data packet (e.g., a second control data packet of FIG. 10), in operation 1230, the gateway may inspect a protection header of the control data packet. The gateway may inspect the protection header of the control data packet based on operations included in operation 1220, an order of each operation is merely illustrative, and the order may be changed. Furthermore, if necessary, the gateway may omit at least some of the operations included in operation 1230. When any inspection of one of the operations included in operation 1230 fails, the gateway may immediately perform operation 1250 without performing subsequent operations.

In operation 1232, the gateway may identify validity of a protection information ID included in the control data packet. For example, the gateway may identify the protection information ID included in the control data packet and may identify whether there is the identified protection information ID in a control data packet protection information table stored in the gateway. When the identified protection information ID is not included in the control data packet protection information table, the gateway may determine that the inspection fails and may drop the received data packet in operation 1250.

When the identified protection information ID is included in the control data packet protection information table, in operation 1234, the gateway may identify validity of authentication information included in the protection header. For example, the gateway may determine whether an OTP included in the protection header is valid based on OTP verification information and an algorithm in the control data packet protection information table. When there is no OTP in the received data packet or when OTP verification fails, the gateway may determine that the inspection fails and may drop the received data packet in operation 1250.

When it succeeds the inspection according to operation 1232 and operation 1234, the gateway may determine that it succeeds in inspecting the protection header of the control data packet and may forward a data packet to an external server (e.g., a controller 202 of FIG. 5) in operation 1240.

According to an embodiment, to block access of an unauthorized terminal, in operation 1220 before performing operation 1230, the gateway may further perform blacklist inspection. For example, the gateway may identify whether a source IP included in an IP header of the received data packet is included in a blacklist. When the source IP is included in the blacklist, the gateway may drop the received data packet without inspecting a protection header of the control data packet. When the source IP is not included in the blacklist, the gateway may perform operation 1230.

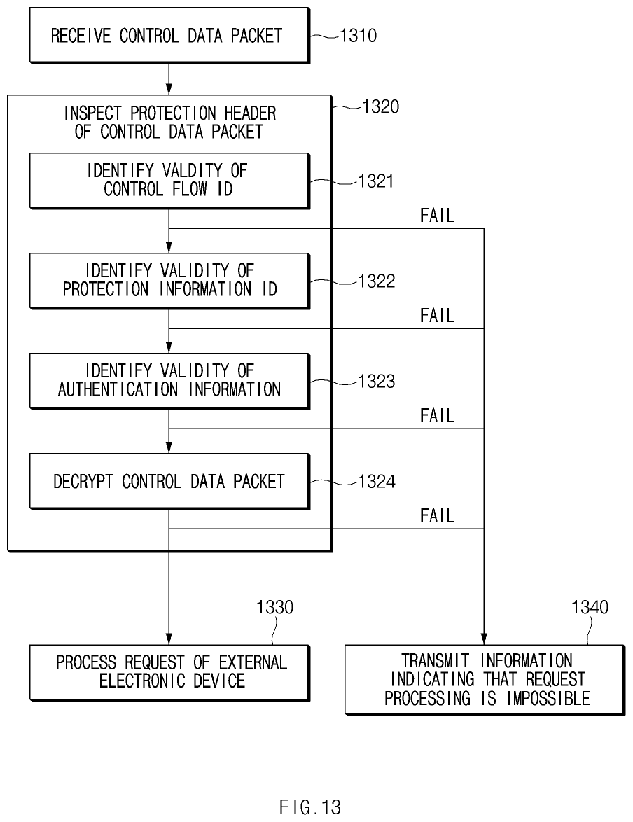

FIG. 13 illustrates an operational flowchart of a controller for controller access according to various embodiments. Operations described below may be performed by means of a controller 202 of FIG. 10. The controller may be referred to as a ‘server’.

Referring to FIG. 13, in operation 1310, the controller may receive a control data packet (e.g., a second control data packet of FIG. 10) from a gateway (e.g., a gateway 203 of FIG. 10).

In operation 1320, the controller may inspect a protection header of the received control data packet. The controller may inspect the protection header of the control data packet by means of operations included in operation 1320, an order of each operation is merely illustrative, and the order may be changed. Furthermore, if necessary, the controller may omit at least some of the operations included in operation 1320. When any inspection of one of the operations included in operation 1320 fails, the controller may immediately perform operation 1340 without performing subsequent operations.

In operation 1321, the controller may identify validity of a control flow ID included in the control data packet. For example, the controller may identify the control flow ID included in the control data packet and may identify whether the identified control flow ID is authorized control flow which is present in a control flow table. When there is no control flow ID in the control data packet or when the identified control flow ID is not authorized, the controller may determine that the inspection fails and may transmit information indicating that it is impossible to process a request of a terminal (e.g., a terminal 201 of FIG. 5) in operation 1340.

When the control flow ID is valid, in operation 1322, the controller may identify validity of a protection information ID included in the control data packet. For example, the controller may identify the protection information ID included in the control data packet and may identify whether there is the identified protection information ID in a control data packet protection information table stored in the controller. When the identified protection information ID is not included in the control data packet protection information table, the controller may determine that the inspection fails and may transmit the information indicating that it is impossible to process the request of the terminal in operation 1340.

When the identified protection information ID is included in the control data packet protection information table, in operation 1323, the controller may identify validity of authentication information included in a protection header of the control data packet. For example, the controller may determine whether an OTP included in the protection header is valid based on verification information and an algorithm corresponding to the identified OTP in the control data packet protection information table. When there is no OTP in the received data packet or when OTP verification fails, the controller may determine that the inspection fails and may transmit the information indicating that it is impossible to process the request of the terminal in operation 1340.

When the verification succeeds, in operation 1325, the controller may decrypt the received control data packet using a decryption key included in control data packet information. When the decryption fails, the controller may transmit the information indicating that it is impossible to process the request of the terminal in operation 1340.

When the operations included in operation 1320 are completed, in operation 1330, the controller may process the request of the terminal. For example, the controller may remove the protection header of the received, control data packet and may process the controller control request of the terminal, which is indicated by the control data packet (e.g., a payload). The controller may transmit the processed result to the terminal.

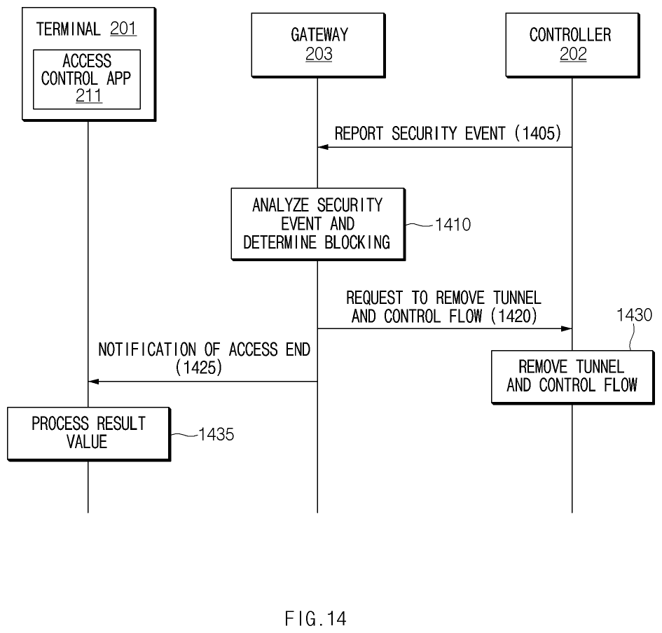

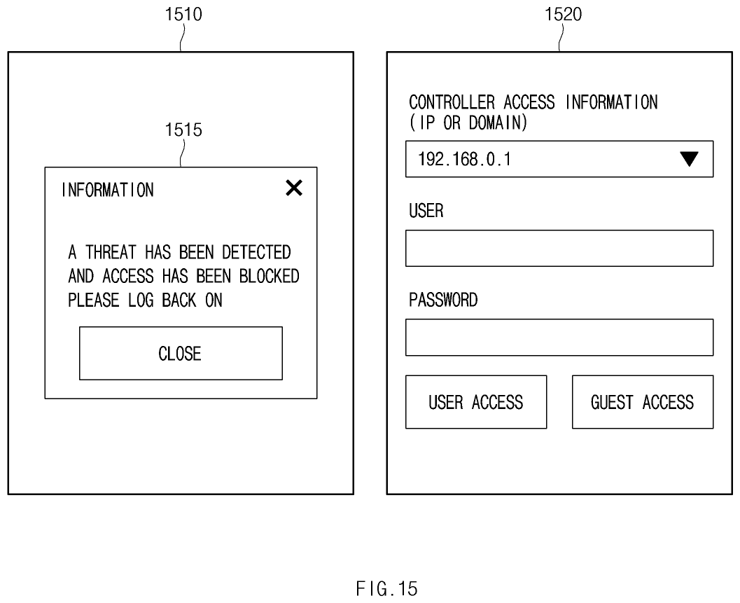

FIGS. 14 and 15 illustrate an operation for access end according to various embodiments. FIG. 14 illustrates a signal sequence diagram for access end. FIG. 15 illustrates a user interface screen indicating that access is ended.

Referring to FIG. 14, in operation 1405, a gateway 203 may collect a control data packet in which it fails to inspect a protection header and may report a security event associated with the failure to a controller 202. According to an embodiment, the gateway 203 may transmit a security event at a specified time interval and may transmit a security event whenever failure in authentication and integrity check is detected.

Although not illustrated in FIG. 14, the controller 202 may collect information associated with a control data packet in which authentication and integrity check fail in the controller 202, other than the security event received from the gateway 203. Furthermore, the controller 202 may receive a security event from an access control application 211 of the terminal 201 or another entity which is not shown in FIG. 14.

In operation 1410, the controller 202 may analyze at least one security event collected from the gateway 203 or the controller 202. Based on the analyzed result, the controller 202 may determine that a threat level of the terminal 201 is high or when the terminal 201 has a potential threat. For example, the controller 202 may determine a threat level of the terminal 201 based on the number of times that it fails in authentication and integrity check of the control data packet of the terminal 201 or the number of times that it fails in the authentication and integrity check during a certain time. According to an embodiment, the controller 202 may determine the threat level of the terminal 201 for each identification information (e.g., each IP address, each MAC address, each terminal ID, or each user ID) of the terminal 201. When it is determined that the threat level of the terminal 201 is high, the controller 202 may determine blocking of the terminal 201. When the blocking of the terminal 201 is determined, the controller 202 may search for control flow corresponding to identification information (e.g., an IP address, a MAC address, a terminal ID, or a user ID) of the terminal 201, the blocking of which is determined, and may remove the found control flow. For another example, the controller 202 may add the identification information of the terminal 201, the blocking of which is determined, to a blacklist to block temporary or permanent access of the terminal 201.

In operation 1420, the controller 202 may request the gateway 203 to remove control flow associated with the blocked terminal 201 and a tunnel dependent on the control flow. In response to receiving the request, in operation 1430, the gateway 203 may remove the control flow associated with the terminal 201 and the tunnel. As the control flow and the tunnel are removed, the terminal 201 may be in a separated state incapable of transmitting a data packet to the controller 202 and a destination network.

In operation 1425, the controller 202 may transmit information providing a notification that the access of the terminal 201 is ended by the controller 202 to the terminal 201. In response to receiving the notification, in operation 1435, the terminal 201 may process a result value. For example, referring to FIG. 15, the terminal 201 may output a user interface screen 1510 on its display. The user interface screen 1510 may include a user interface 1515 for notifying a user that the access is blocked and guiding the user to access it again. The terminal 201 may attempt to perform controller access again depending on a user input. For example, the terminal 201 may output a user interface screen 1520 (e.g., a user interface screen 610 of FIG. 6) and may attempt to perform control access again based on information of the controller 201 or user information, which is received on the user interface screen 1520.

1. A node, comprising:
a communication circuitry;
a processor operatively connected with the communication circuitry; and
a memory, operatively connected with the processor, storing an access control application,
wherein the memory stores instructions, when executed by the processor, causing the node to:
detect a controller access event for an external server by means of the access control application;
insert a first protection header into a first control data packet for requesting controller access, wherein the first protection header includes a protection information identifier (ID) for identifying protection information used to authenticate the first control data packet and first authentication information which is generated based on the protection information and is used for authentication and integrity check of the first control data packet; and
transmit the first control data packet into which the first protection header is inserted to the external server, using the communication circuitry.

2. The node of claim 1, wherein the first authentication information includes at least one of one-time password (OTP) information or electronic signature information.

3. The node of claim 1, wherein the instructions cause the node to:
calculate a data packet length, into which the first protection header is inserted, which increases when a payload of the first control data packet is encrypted, by means of the access control application; and
fragment the first control data packet based on the calculated value and a maximum transmission unit (MTU) of the node.

4. The node of claim 1, further comprising:
a display,
wherein the instructions cause the node to:
receive a first response to the first control data packet from the external server;
store identification information of control flow and updated protection information, when the first response indicates that the node is accessible; and
output a user interface screen indicating that access of the node is blocked on the display, when the response indicates that the node is inaccessible.

5. The node of claim 4, wherein the instructions cause the node to:
detect a controller control event for the external server, by means of the access control application;
insert a second protection header into a second control data packet for requesting controller control, the second protection header including the protection information ID, the identification information of the control flow, and second authentication information generated based on the updated protection information; and
transmit the second control data packet into which the second protection header is inserted to the external server, using the communication circuitry.

6. The node of claim 2, wherein the OTP information includes an OTP value and an OTP counter value.

7. The node of claim 1, further comprising:
a display,
wherein the instructions cause the node to:
receive information indicating access end from the external server; and
output a user interface screen indicating access end on the display based on the received information.

8. A gateway, comprising:
receiving a data packet from a node;
determining that the data packet is a control data packet based on a destination IP and a structure of the received data packet;
inspecting a protection header of the control data packet;
transmitting the control data packet to an external server, when the inspection succeeds; and
dropping the control data packet, when the inspection does not succeed.

9. The gateway of claim 8, wherein the gateway is configured to:
identify whether a source IP included in an IP header of the control data packet is included in a blacklist of the gateway before inspecting the protection header;
drop the control data packet, when the source IP is included in the blacklist; and
inspect the protection header, when the source IP is not included in the blacklist.

10. The gateway of claim 8, wherein the gateway is configured to:
identify whether a protection information ID included in the protection header is present in a table stored in the gateway to inspect the protection header; and
identify validity of authentication information included in the protection header.

11. The gateway of claim 10, wherein the authentication information includes at least one of OTP information or electronic signature information.

12. A server, comprising:
a communication circuitry;
a memory storing a database; and
a processor operatively connected with the communication circuitry and the memory,
wherein the processor is configured to:
receive a first control data packet of a node requesting controller access, from a gateway;
inspect a first protection header of the first control data packet;
generate control flow between the node and the server, the inspection of the first protection header succeeds; and
drop the first control data packet, when the inspection of the first protection header fails.

13. The server of claim 12, wherein the processor is configured to:
identify whether a protection information ID included in the first protection header is present in a table stored in the database to inspect the first protection header; and
identify validity of authentication information included in the first protection header; and
decrypt the first control data packet.

14. The server of claim 13, wherein the authentication information includes at least one of OTP information or electronic signature information.

15. The server of claim 13, wherein the processor is configured to:
merge a plurality of data packets which are fragmented, based on the number and order of packets written in the first protection header.

16. The server of claim 12, wherein the processor is configured to:
generate identification information of the control flow and new protection information for updating protection information used to encrypt the first control data packet; and
transmit the identification information of the control flow and the new protection information to the node, using the communication circuitry.

17. The server of claim 16, wherein the processor is configured to:
receive a second control data packet of the node requesting controller control, from the gateway;
inspect a second protection header of the second control data packet;
process a request of the node, when the inspection of the second protection header succeeds; and
drop the second control data packet, when the inspection of the second protection header fails.

18. The server of claim 17, wherein the processor is configured to:
identify whether identification information of control flow included in the second protection header is present in the database to inspect the second protection header; and
drop the second control data packet, the identification information of the control flow is not present in the database.

19. The server of claim 14, wherein the OTP information includes an OTP value and an OTP counter value.

20. The server of claim 12, wherein the processor is configured to:
receive a security event associated with failure in protection header inspection from the gateway;
determine blocking of the node by analyzing the received security event; and
transmit information indicating that access of the node is ended, using the communication circuitry.
